(19) United States
(12) Patent Application Publication
(10) Pub. No.: US 2006/0101381 A1
(43) Pub. Date: May 11, 2006

(54) Computer method and apparatus for implementing subsets constraints in programming models

(75) Inventor: Kenneth Earle Hussey, Kanata (CA)

Correspondence Address: HAMILTON, BROOK, SMITH & REYNOLDS, 530 VIRGINIA ROAD, PO BOX 9133, CONCORD, MA, 01742-9133, US

(73) Assignee: International Business Machines Corporation, Armonk, NY (US)

(21) Appl. No.: 10/977,794

(22) Filed: Oct. 29, 2004

(51) Int. Cl. G06F 9/44

(52) U.S. Cl. 717/104

(57) ABSTRACT

A computer method and system for implementing subsetting properties and subsets constraints in a programming model. The method and system provide a model element having a subsetting property or a property with a subsets constraint. The invention stores subsets constraints information as annotations to the model element. An interpreter member interprets the stored information and generates therefrom a model that implements subsetted properties with their superset of values and implements subsetting properties with their subset of values.

### BACKGROUND OF THE INVENTION

With the proliferation of software products and services, attempts have been made to codify and/or standardize the designing of software and software architecture. Examples include:

The Booch Method and Modeling Language (see “Object Oriented Analysis and Design” by Grady Booch);

James Rumbaugh and Associates' Object Modeling Technique (OMT);

the Object Oriented Software Engineering (OOSE) method by Ivar Jacobson; and

the Unified Modeling Language (UML) which combines the foregoing and industry best practices.

The UML is a visual modeling language (with formal syntax and semantics) for communicating a model or conceptionalization. Thus the modeling language specification specifies modeling elements, notation and usage guidelines and not order of activities, specification of artifacts, repository interface, storage, run-time behavior and so forth. In general, at the modeling level a “problem” is posed in terms of a customer's needs and requirements and may be referred to as the business problem system. The software designer develops a “solution” software product and or service that addresses the problem. The UML syntax enables software designers to express (specify and document) the subject problems and solutions in a standardized manner, while the UML semantics enable knowledge about the subject system to be captured and leveraged during the problem solving phase. See “UML in a Nutshell” by Simon Si Alhir, published by O'Reilly & Associates, Sept. 1998. As such, the UML enables the sharing of information (including prior solution portions) and extension (without reimplementation) of core object oriented concepts (analysis and design) during the iterative problem-solving process for designing software products.

In UML 2.0, a navigable property can be marked as a subset of another as long as the owner of the subsetting property is the same as, or a specialization of, the subsetted property. The collection of values associated with an instance of the subsetting property must be included in, or the same as, the collection of values associated with an instance of the corresponding subsetted property. A property is identified as a subset of another using a subsets constraint on the subsetting property that contains the name of the subsetted property.

The Rose model for UML 2.0 contains many attributes and associations that are constrained to be subsets of other attributes/associations. There are, however, no known mechanisms for generating Java code that enforces these constraints. The Eclipse Modeling Framework (EMF) can be used to generate Java code from a Rose model, but provides no automated support for processing property subsets. Although constraints are accessible from the Rose model that is traversed during code generation, this information is discarded by EMF.

### SUMMARY OF THE INVENTION

The present invention overcomes the above limitation and provides a mechanism for generating Java or similar code that enforces subsets constraints. In a preferred embodiment, a computer method and system implement subsetting properties and subsets constraints in a programming model. The method and system provide a model element having a subsetting property or a property with a subsets constraint. The preferred embodiment stores subsets constraints information as annotations to the model element. An interpreter member of the invention interprets the stored information and generates therefrom a model that implements subsetted properties with their superset of values and implements subsetting properties with their subset of values.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic view of a non-list property (“owningAssociation”) subsetting another non-list property (“association”).

FIG. 2 is a schematic view of a non-list property (“representation”) subsetting a list property (“occurrence”).

FIG. 3 is a schematic view of a list property (“nestedPackage”) subsetting another list property (“owned member”).

FIG. 4 is a block diagram of a preferred embodiment of the present invention.

FIG. 5 is a schematic illustration of computer systems implementing methods of the present invention.

FIG. 6 is a schematic view of a computer environment in which the principles of the present invention may be implemented.

FIG. 7 is a block diagram of the internal structure of a computer from the FIG. 6 computer environment.

### DETAILED DESCRIPTION OF THE INVENTION

A description of preferred embodiments of the invention follows.

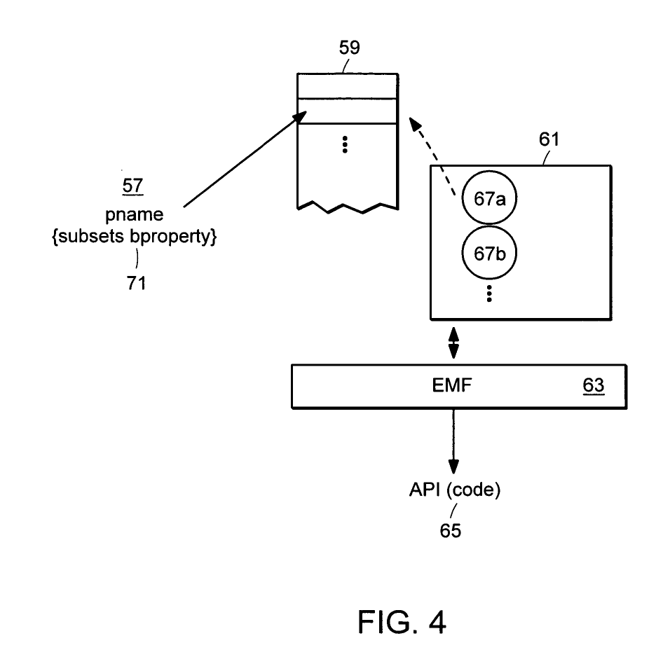

Since it would be desirable to generate code that in some way reflects so called “subsets” constraints, the present invention records information about subsets constraints as annotations on the code generation model that it builds. FIG. 4 is illustrative. Shown in FIG. 4 is a model representation 61 of a desired software product being designed by a user of the present invention method and apparatus. The present invention tool assists with forming the meta-data design of the subject software product. The meta-data design includes meta-data classes, and instances thereof. Classes are defined with attributes, one of which is termed a “property”. Properties are indicated in the model representation 61 with a name and have a respective value (either defined in the model or derived at run time, for example). Properties also have a type and a multiplicity (number of program objects it relates or applies to). There are constraints on properties based on, for example, respective allowable range of values, unions of sets of values, redefinition of property name, type and/or multiplicity and the like. The “subsets” constraint of a given property (termed the subsetting property) defines the value of that property to be a subset of another property (the subsetted property).

In the example illustrated in FIG. 4, property “pname” 57 of a model element 67 in model 61 has a subsets constraint (indicated between curly brackets). The “pname” property 57 (subsetting property) has a value that is a subset of the values of the subsetted “bproperty” property 71. Thus for every value in pname 57, that specific value must be in “bproperty” 71. Any time values are added to pname 57, those values must be added to bproperty 71. Likewise, any time values are removed from bproperty 71, those values must be removed from pname 57. So bproperty 71 is a superset covering pname 57. For ease of discussion, the example subsets property constraint is generally referenced 57.

The present invention records an indication of the subsets constraint 57 in annotations 59 corresponding to the model element 67. The annotations 59 may be stored in a list or other appropriate data structure. In particular, the annotations 59 maintain a superset list corresponding to bproperty 71 in this example and a subset list corresponding to pname property 57. If a value is added to the subset list, then the present invention model (e.g., via interpreter 63) adds to the superset list. Similarly, if a value is removed from the superset list, then the present invention system (model interpreter 63) removes the value from the subset list.

Further, containment properties that are subsets of other containment properties are made non-containment features in model 61 since their values cannot be contained in two locations (in each property). In one embodiment, Java templates are used to automatically generate code for these subsetting properties 57 based on annotations 59. The generated comments for the methods associated with these properties indicate for which properties the property represents a subset or superset, and code is generated for the bodies of these methods to enforce such constraints 57. Automatically generated implementations of subset properties ensure that any member of the subset is also a member of its superset.

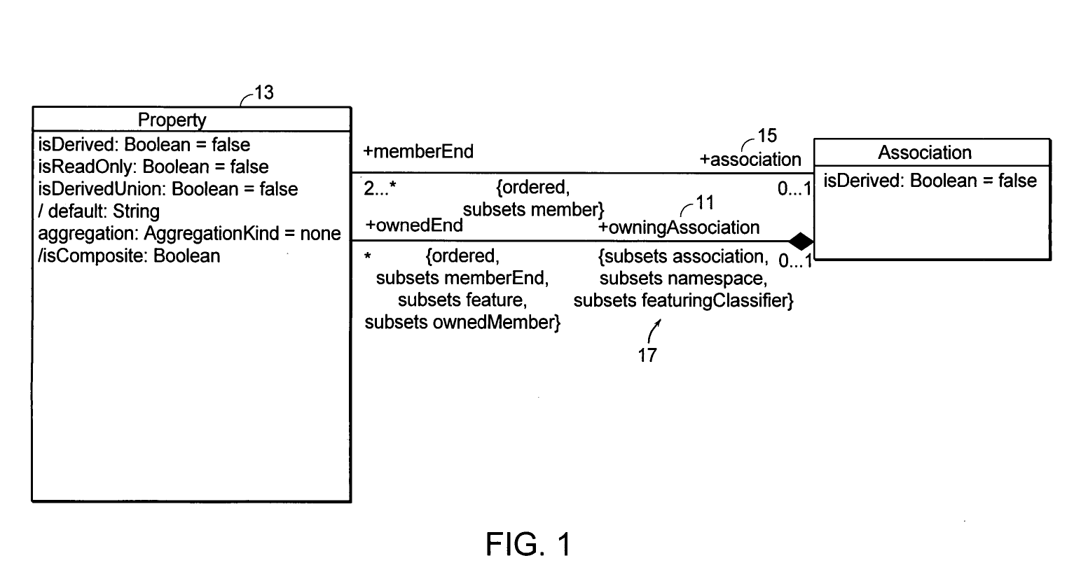

In a preferred embodiment, the subject user model 61 is a Rose model that represents the code generation (model) of interest, i.e., the software product model being designed. The present invention records (in the form of annotations 59 in respective parts of the code generation model 61) constraint information for each subset property (for example, at 57 and 71). Next the preferred embodiment employs EMF at 63 to generate Java templates (or like code) from the annotated Rose model 61, 59. The generated Java template or the like carries out instruction statements described above and further discussed below for adjusting superset and subset property values. The resulting EMF 63 output is an API 65 (e.g., in an object oriented or other programming language) that correctly implements the subsets constraint 57. Further specific examples are discussed below in FIGS. 1 through 3.

There are several scenarios to consider with respect to subsets.

First, consider the case where a non-list property subsets another non-list property. For example, the owningAssociation property 11 of the Property class 13 subsets its “association” property 15, as shown in the class diagram of FIG. 1. The subsets constraint among other subsets constraints are shown at 17 in curly brackets.

In this case, the subset constraint 17 is enforced by ensuring that whenever the value of the subset feature (e.g., owningAssociation 11) is changed, the value of the superset feature (e.g., association 15) is also changed to the same value (unless the new value is null and the superset feature is not the container). As mentioned above, the present invention model interpreter 63 generates new code at the end of the setter for the subset feature (owningAssociation) 11 that resembles the following:

if (null != newOwningAssociation ∥ oldOwningAssociation ==
association) {
setAssociation(newOwningAssociation);
}

The inverse (superset) constraint is enforced by ensuring that whenever the value of the superset feature 15 is changed, the value of the subset feature 11 is changed to be null (unless the new value is null or the subset feature is already set to that value). Model interpreter 63 generates new code at the end of the setter for the superset feature (association) 15 that resembles the following:

```
    if (null != getOwningAssociation( ) && newAssociation !=
getOwningAssociation( )) {
        setOwningAssociation(null);
    }
```

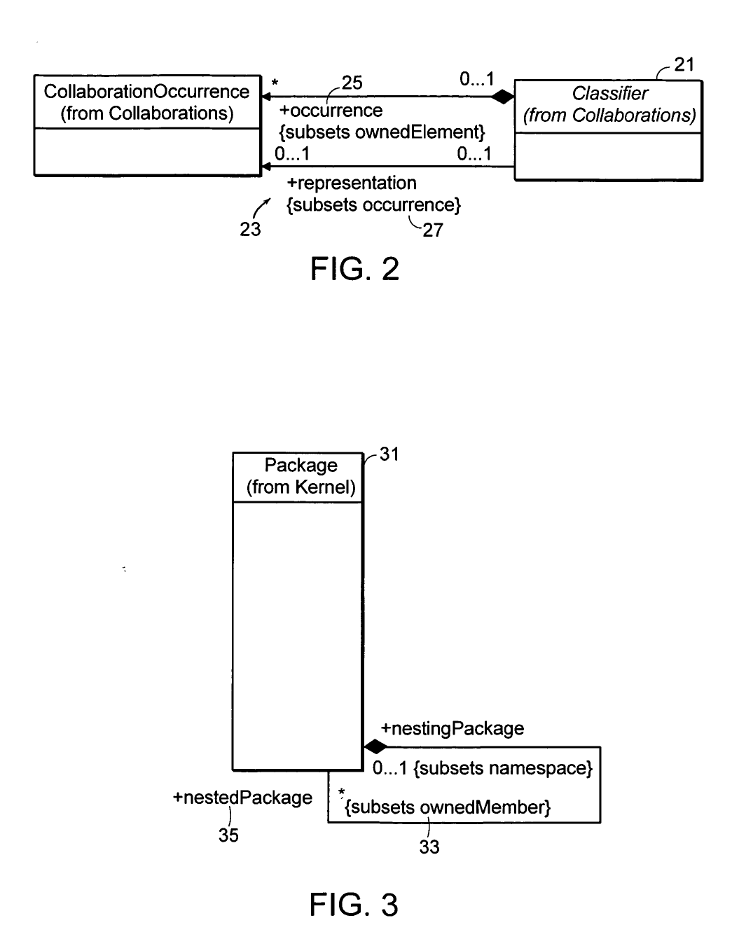

Next, consider the case where a non-list property subsets a list property. For example, the non-list representation property 23 of the Classifier class 21 subsets its list occurrence property 25, by subsets constraint 27 shown in the class diagram of FIG. 2.

In this case, the subset constraint 27 is enforced by ensuring that whenever the value of the subset feature 23 is changed, the new value is added to the superset feature 25 collection (unless it is null or is already there). The present invention generates new code at the beginning of the setter for the subset feature (representation) 23 that resembles the following:

if (null != newRepresentation &&
!getOccurrence( ).contains(newRepresentation)) {
getOccurrence( ).add(newRepresentation);
}

The inverse (superset) constraint is enforced via one of a number of new list subclasses (namely SupersetEObjectContainmentEList) that keeps its contents in sync with one or more subset features 23 by, for example, removing an element from its subset list(s) whenever an element is removed from it. Model interpreter 63 generates new code for the getter of the superset feature (occurrence) 25 that resembles the following:

```
    if (occurrence == null) {
        occurrence = new SupersetEObjectContainmentEList
(CollaborationOccurrence.class, this,
Uml2Package.CLASSIFIER_{——}OCCURRENCE,
new int[ ] {Uml2Package.CLASSIFIER_{——}REPRESENTATION});
    }
```

Finally, consider the case where a list property subsets another list feature. For example, the nestedPackage property 35 of the Package class 31 subsets its ownedMember property 33, as shown in the class diagram of FIG. 3.

In this case, the subset constraint is enforced via a one of a number of new list subclasses (namely SubsetEObjectWithInverseResolvingEList) that keeps its contents in sync with one or more superset features 33 by, for example, adding an element to its superset list(s) whenever an element is added to it. Model interpreter 63 generates new code for the getter of the subset feature (nestedpackage) 35 that resembles the following:

```
    if (nestedPackage == null) {
        nestedPackage = new SubsetEObjectWithInverseResolvingEList
(org.eclipse.uml2.Package.class, this,
Uml2Package.PACKAGE_{——}NESTED_PACKAGE, new int[ ]
{Uml2Package.PACKAGE_{——}OWNED_MEMBER},
Uml2Package.PACKAGE_{——}NESTING_PACKAGE);
    }
```

The inverse (superset) constraint is enforced via one of a number of new list subclasses (namely SupersetEObjectContainmentEList) that keeps its contents in sync with one or more subset features 35 by, for example, removing an element from its subset list(s) whenever an element is removed from it. Model interpreter 63 generates new code for the getter of the superset feature (ownedMember) 33 that resembles the following:

```
    if (ownedMember == null) {
        ownedMember = new SupersetEObjectContainmentEList
(PackageableElement.class, this,
Uml2Package.PACKAGE_{——}OWNED_MEMBER, new int[ ]
{Uml2Package.PACKAGE_{——}NESTED_PACKAGE});
    }
```

Note that, in addition to the generated code described above, one embodiment of the present invention also includes a set of custom commands that embody similar behavior so that changes made using the EMF.Edit command framework can be successfully undone and redone.

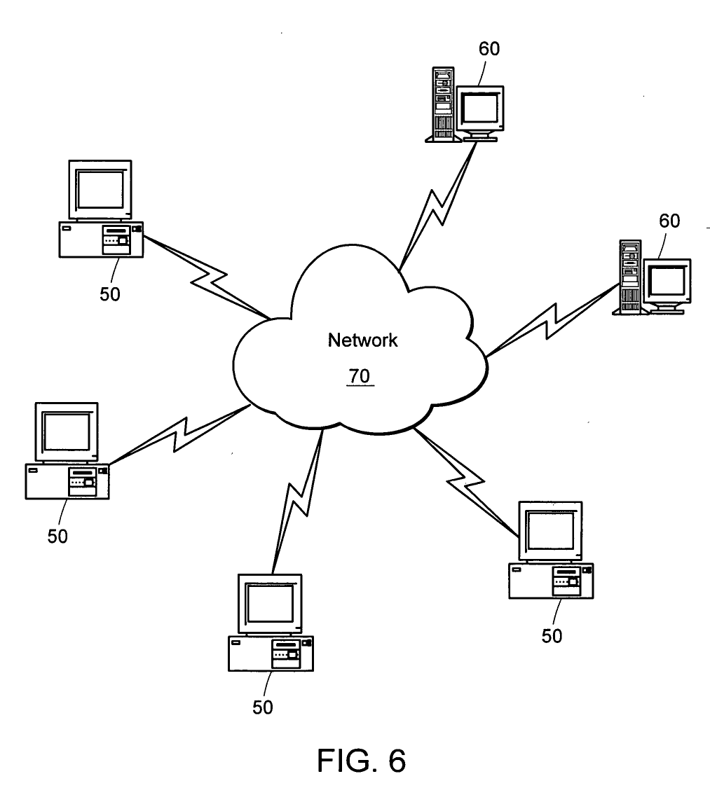

FIG. 6 illustrates an example computer environment in which the present invention operates. Client computer(s) 50 and server computer(s) 60 provide processing, storage, and input/output devices executing application programs and the like. Client computer(s) 50 can also be linked through communications network 70 to other computing devices, including other client computer(s) 50 and server computer(s) 60. Communications network 70 can be part of the Internet, a worldwide collection of computers, networks, and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. In another embodiment of the present invention, the methods are implemented on a stand-alone computer. In either network or standalone, the invention output software design and models (API's) are sharable and reusable among users.

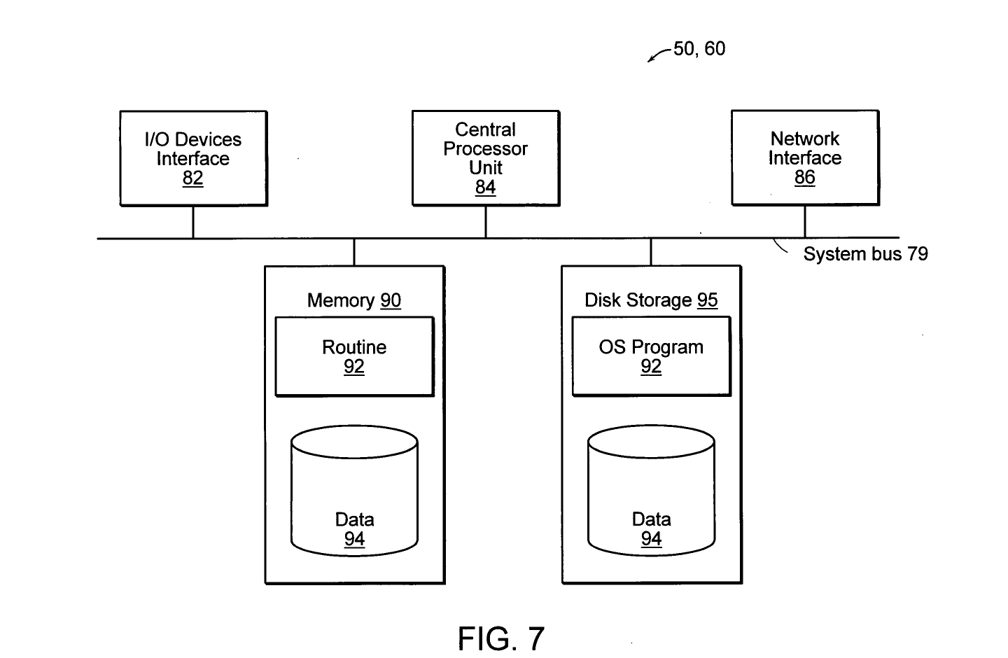

FIG. 7 is a diagram of the internal structure of a computer (e.g., client computer(s) 50 or server computers 60) in the computer system of FIG. 6. Each computer contains system bus 79, where a bus is a set of hardware lines used for data transfer among the components of a computer. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., displays, printers, speakers, etc.) to the computer. Network interface 86 allows the computer to connect to various other devices attached to a network (e.g., network 70 of FIG. 6). Memory 90 provides volatile storage for computer software instructions used to implement an embodiment of the present invention (e.g., EMF/model interpreter code 63 and Rose models 61 of subject Program Routines 92 and Data 94). Disk storage 95 provides non-volatile storage for computer software instructions and data used to implement an embodiment of the present invention. Central processor unit 84 is also attached to system bus 79 and provides for the execution of computer instructions.

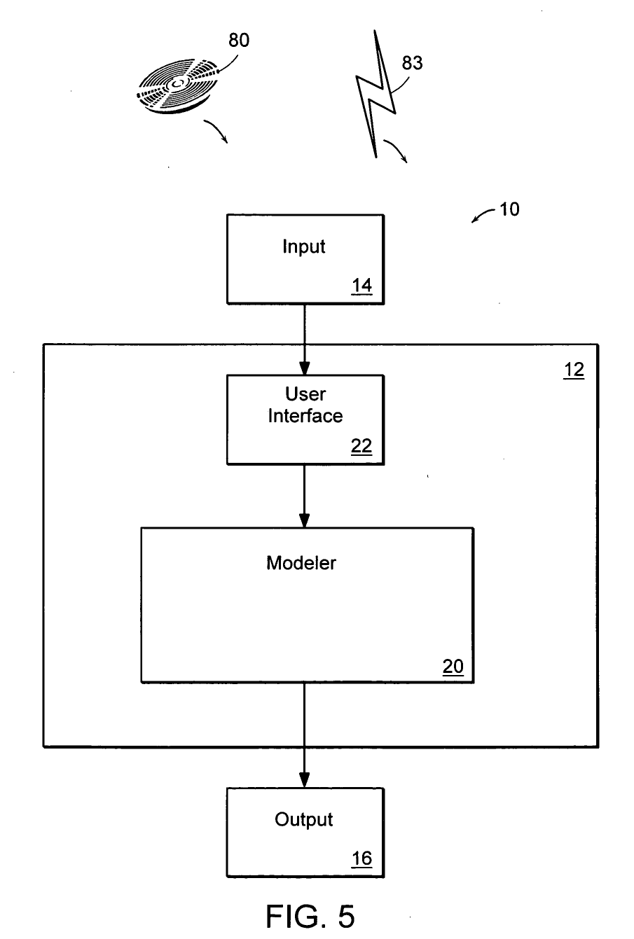

Referring now to FIG. 5 illustrated is another computer system 10 embodying the present invention techniques mentioned above. Generally, computer system 10 includes digital processor 12 in which subject modeling language and EMF code 20 are utilized. Input means 14 provides user commands, selections (generally communication) to computer system 10.

Responsive to input means 14 is user interface 22. User interface 22 receives user input data from input means 14 and provides input data for processing and manipulation at 20. The methods of the invention are implemented at 20 for designing Application Program Interfaces 65 that enforce subsets constraints in Java, UML, EMF and the like which are output at 16. Output 16 may be a display monitor, printer or other computer.

In one embodiment, computer program product 80, including a computer readable medium (e.g., a removable storage medium such as one or more DVD-ROM's, CD-ROM's, diskettes, tapes, etc.) provides at least a portion of the software instructions at 20 and/or user interface 22. Computer program product 80 can be installed by any suitable software installation procedure, as is well known in the art. In another embodiment, at least a portion of the software instructions may also be downloaded over a wireless connection. Computer program propagated signal product 83 embodied on a propagated signal on a propagation medium (e.g., a radio wave, an infrared wave, a laser wave, a sound wave, or an electrical wave propagated over a global network such as the Internet, or other network(s)) provides at least a portion of the software instructions at 20 and/or user interface 22.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 80 is a propagation medium that the computer system 10 may receive and read, such as by receiving the propagation medium and identifying a propagated signal embodied in the propagation medium, as described above for computer program propagated signal product 83.

Generally speaking, the term “carrier medium” or transient carrier encompasses the foregoing transient signals, propagated signals, propagated medium, storage medium and the like.

While this invention has been particularly shown and described with references to preferred embodiments thereof, it will be understood by those skilled in the art that various changes in form and details may be made therein without departing from the scope of the invention encompassed by the appended claims.

For example, the model interpreter 63 may be implemented in UML, EMF and other modeling languages. The produced API or target code 65 may be in Java, UML, EMF, XML and the like.

What is claimed is:

1. A computer method for modeling subsets constraints in a programming model comprising:
providing a model element having a property with a subsets constraint;
storing indications of the subsets constraint in a manner corresponding to the model element; and
interpreting the stored indications and generating therefrom a model that implements subsetted properties and subsetting properties.

2. A method as claimed in claim 1 wherein the step of interpreting and generating employs EMF (Eclipse Modeling Framework).

3. A method as claimed in claim 1 wherein the step of generating generates Java code that implements the subsets constraint.

4. A method as claimed in claim 1 wherein the step of storing includes recording information about the subsets constraint as an annotation to the model element.

5. A method as claimed in claim 4 wherein the recorded information includes subset values and superset values.

6. A carrier medium comprising computer readable code for controlling a processor to implement modeling of subsets constraints in a programming model, by carrying out the steps of:
providing a model element having a property with a subsets constraint;
storing indications of the subsets constraint in a manner corresponding to the model element; and
interpreting the stored indications and generating therefrom a model that implements the property including implementing subsetted properties and subsetting properties.

7. A carrier medium as claimed in claim 6 wherein the step of interpreting and generating employs EMF (Eclipse Modeling Framework).

8. A carrier medium as claimed in claim 6 wherein the step of generating generates JAVA code that implements the subsets constraint.

9. A carrier medium as claimed in claim 6 wherein the step of storing includes recording information about the subsets constraint as an annotation to the model element.

10. A carrier medium as claimed in claim 9 wherein the recorded information includes subset values and superset values.

11. A carrier medium as claimed in claim 6 wherein the carrier medium is any one of or a combination of a propagated signal, a transient carrier and a storage medium.

12. A computer system for implementing subsets constraints in a target code, comprising:
modeling means for providing a model element having a property with one or more subsets constraints;
means for storing subsets constraint information; and
an interpreter for interpreting the stored subsets constraints information and generating target code therefrom that implements subset values and superset values of the subsets constraints.

13. A computer system as claimed in claim 12 wherein the modeling means includes a Rose model, and the interpreter employs EMF.

14. A computer system as claimed in claim 12 wherein the target code is JAVA.

15. A computer system as claimed in claim 12 wherein the means for storing include annotations to the model element.

16. A computer system as claimed in claim 15 wherein the stored information includes subset values and superset values of each subsets constraint.

17. A carrier medium comprising computer readable code for controlling a processor to implement subsetting properties in a target code, by carrying out the steps of:
providing a model element having a subsetting property;
storing subsetting information from the subsetting property; and
interpreting the stored subsetting information and generating target code therefrom that implements subset values corresponding to the subsetting property.

18. A carrier medium as claimed in claim 17 wherein the step of interpreting and generating employs EMF (Eclipse Modeling Framework).

19. A carrier medium as claimed in claim 17 wherein the target code is JAVA.

20. A carrier medium as claimed in claim 17 wherein the step of storing includes recording subsetting information as one or more annotations to the model element.

21. A carrier medium as claimed in claim 17 wherein the carrier medium is any one of or a combination of a propagated signal, a transient carrier and a storage medium.

22. A carrier medium as claimed in claim 17 wherein the stored subsetting information includes subset values corresponding to the subsetting property and superset values corresponding to a respective subsetted property; and
the step of interpreting and generating takes into account the superset values and therefrom effectively maintains the subset values.

23. A carrier medium as claimed in claim 22 further carrying out the step of maintaining the superset values from changes made to the subset values.
